(19) United States
(12) Patent Application Publication
(10) Pub. No.: US 2025/0002410 A1
(43) Pub. Date: Jan. 2, 2025

(54) RIGID, NON-FLEXIBLE FIBER REINFORCED INSULATION COMPOSITE

(71) Applicant: ASPEN AEROGELS, INC., Northborough, MA (US)

(72) Inventors: Nicholas Anthony Zafiropoulos, Wayland, MA (US); Kathryn deKrafft, Hudson, MA (US); Wenting Dong, Northborough, MA (US)

(21) Appl. No.: 18/695,340

(22) PCT Filed: Oct. 14, 2022
(86) PCT No.: PCT/IB2022/059886

§ 371 Date: Mar. 25, 2024

Related U.S. Application Data
(60) Provisional application No. 63/256,123, filed on Oct. 15, 2021.

(51) Int. Cl. C04B 20/00; C04B 35/14; C04B 38/00; C04B 38/10; C04B 41/00; H01M 10/658

(52) U.S. Cl. CPC C04B 20/0048; C04B 35/14; C04B 38/0067; C04B 38/106; C04B 41/0072; H01M 10/658; C04B 2235/3418; C04B 2235/3826; C04B 2235/5232; C04B 2235/604

(57) ABSTRACT

The present disclosure relates to non-flexible composite insulation materials comprising a metal oxide matrix reinforced with a fibrous material embedded therein. Specifically, the present disclosure relates to use of the non-flexible composite insulation materials for thermal batteries and the like. The non-flexible composite insulation materials with low thermal conductivity provided herein is capable of meeting the mechanical requirements for thermal battery design yet provides improved handleability compared to the commercially available insulators.

### CROSS-REFERENCE TO RELATED APPLICATIONS

This application claims priority to U.S. Provisional Application No. 63/256,123, filed Oct. 15, 2021, which is incorporated herein by reference in its entirety.

### GOVERNMENT SUPPORT

This invention was made with Government support under Grant Number FA9422-17-C-8001 awarded by US Air Force Nuclear Weapons Center. The Government has certain rights in this invention.

### FIELD OF THE TECHNOLOGY

The present disclosure relates generally to composite insulation materials for thermal batteries and the like. More specifically, the present disclosure relates to non-flexible composite insulation materials with improved handleability comprising a metal oxide matrix reinforced with a fibrous material, methods of preparing the same, and use thereof for insulating battery components.

### BACKGROUND

Thermal batteries are high-temperature power sources typically operating between 350° C. and 600° C. Such batteries use electrochemical cells which are activated by heat to produce electricity. These electrochemical cells generally include suitable anode and cathode elements separated by an ionically conducting molten salt which is solid and non-conducting at normal or ordinary operating temperatures. When the battery cells exceed the melting temperature of the electrolyte, the electrolyte may fuse or melt and become conductive, permitting the battery to function and produce electricity by well-known electrochemical reactions. A typical example of such a thermal battery can be found in U.S. Pat. No. 3,558,363.

A thermal battery has been employed almost exclusively in military and defense applications because it offers an exceptionally high power density, as well as a maintenance free storage life often in excess of twenty years. However, thermal batteries have certain inherent limitations and disadvantages. For example, when thermal battery cells get activated, they generate heat during operation, which can be detrimental to the nearby environment such as electronic packages. In addition, the active life and the power density of the batteries are restricted by the length of time that the electrolyte stays molten. Over time, as heat escapes the battery, the electrolyte may begin to freeze, resulting in increasing impedance and eventually resulting in no ionic conduction.

Thermal insulation of battery cells is responsible for the retention of the heat in the system in order to keep the electrolyte molten for as long as possible. Insulation also ensures the maintenance of the safety by preventing heat damaging the environment of the surrounding system components due to thermal escape.

Thermal insulation of battery cells is responsible for the retention of the heat in the system in order to keep the electrolyte molten for as long as possible. Insulation also ensures the maintenance of the safety by preventing heat damaging the environment of the surrounding system components due to thermal escape. Multiple layers of flexible insulation material can be directly wrapped around the cell stack to insulate the cell stack axially. These kind of flexible insulation materials can line the interior surface, the exterior surface, or both interior and exterior surfaces, of a battery casing (battery container). In the case that battery casing possesses (an) end cover(s) or (a) cap(s), insulation disks that are made from rigid insulation materials can be used at the top and bottom of the cell stack to improve insulation.

Conventional types of insulation, such as foam or fiber sheets, can tolerate high temperatures, but have a relatively low capacity for insulation or thermal containment. For such materials, the thickness of the insulation must be increased in order to provide effective thermal management. However, the space requirements for battery casing limit the size of the module, as well as the space between cells within the module. Especially for smaller size thermal batteries, the volume of the insulation material that can be provided becomes limited.

An example of thermal insulation material currently available for commercial use is Microtherm® rigid boards/panels which are microporous insulation material available from Promat Inc. (Tisselt, Belgium). Microtherm is a composite insulation made with microporous silica embedded in a glass cloth and with silicon carbide as an opacifier. Though Microtherm® has low thermal conductivity at high temperature (e.g., 30 mW/m-K at 600° C.), it is very brittle and dusty during handling and when die-cut. Considering thermal batteries tend to be application specific, a given form factor is generally not used for new applications. A rigid insulation material with comparable or improved thermal properties with better handleability and mechanical integrity is needed.

A need therefore exists for methods and materials that can be used to keep thermal batteries, in general and small thermal batteries in particular operational longer following activation. For applications in which the operational life of the thermal battery following activation is not an issue, such methods and material can be used to reduce the insulation volume requirement, thereby allowing the size of the thermal battery to be reduced in size and mass and to maintain safety of the surrounding environment.

### SUMMARY

Improved thermal insulations such as aerogels have received some attention for use in long-life thermal batteries. Aerogel materials are known to possess about two to six times the thermal resistance of other common types of insulation, e.g., foams, fiberglass, etc. Aerogels can increase effective shielding and thermal insulation without substantially increasing the thickness of the insulation or adding additional weight.

It would be desirable to provide reinforced aerogel compositions with improved performance in various aspects, including in rigidity, handleability, mechanical integrity, thermal conductivity and others, individually and in one or more combinations.

It is an object of the present disclosure to obviate or mitigate at least one disadvantage of previous insulation materials useful for thermal batteries and the like.

Provided herein are non-flexible composite insulation materials and methods of preparing the same to develop effective heat insulation for thermal batteries and the like that can be used to prolong the battery operational time and performance as well as maintain thermal safety.

The non-flexible composite insulation materials provided herein also decrease the risk associated with the use of thermal batteries due to the escape of excess heat to the environment.

In one aspect, the present disclosure relates to a non-flexible composite insulation material comprising a metal oxide matrix, an opacifying compound, and a fibrous material optionally comprising a polymeric binder, wherein the non-flexible composite insulation material is reinforced with the fibrous material. In some embodiments, the non-flexible composite insulation material has a density greater than about 0.20 g/cc and a flexural modulus greater than about 10,000 psi.

In another aspect, the present disclosure relates to a non-flexible composite insulation material comprising a metal oxide matrix reinforced with a fibrous material embedded therein, wherein the fibrous material optionally comprises a polymeric binder, and wherein an opacifying compound is dispersed throughout the metal oxide matrix. In some embodiments, the non-flexible composite insulation material has a density greater than about 0.20 g/cc. In some embodiments, the opacifying compound is present at greater than about 40 weight % relative to metal oxide content within the composite insulation material.

In one aspect, provided herein is a thermal battery comprising the non-flexible composite insulation material according to any aspects and embodiments described above or later in the present disclosure.

In another aspect, provided herein is a method of improving the performance of a thermal battery comprising incorporating the non-flexible composite insulation material according to any aspects and embodiments described above or later in the present disclosure into the thermal battery.

In one aspect, provided herein is a method for preparing a non-flexible composite insulation material, including: providing a reinforced aerogel composite comprising a metal oxide matrix, an opacifying compound, and a fibrous material optionally comprising a polymeric binder; exposing the aerogel composite to a heat treatment in a reduced oxygen or air atmosphere, wherein the heat treatment comprises exposure to one or more temperatures between 500° C. and 700° C.; and mechanically compressing the aerogel composite in the direction perpendicular to the predominant direct of the fibrous material, thereby preparing the non-flexible composite insulation material. Upon compression, the density of the aerogel composite is increased by a factor up to 5-100. In some embodiments, density of the non-flexible composite insulation material is about 5 to 100 times higher than the density of the reinforced aerogel composite. In some embodiments, the reinforced aerogel composite is compressed by less than 80% in volume. In some embodiments, the reinforced aerogel composite is compressed under a pressure of about 500 psi to about 10,000 psi. In one embodiment, the total duration of the heat treatment is between 1 minute and 120 minutes. In some embodiments, the thermal conductivity of the aerogel composite at 600° C. is substantially unchanged relative to an uncompressed reinforced aerogel composite having substantially the same composition.

In another aspect, provided herein is a method of producing a non-flexible composite insulation material, including: providing a casting surface and a flat casting frame, wherein an inner boundary of the casting frame encloses a casting area on the casting surface; providing a sol-gel solution; combining the sol-gel solution with an opacifying compound; placing the fibrous material into the casting area; combining the sol-gel solution with the fibrous material in the casting area; allowing the sol-gel solution to transition into a gel material, thereby forming a reinforced gel; drying the reinforced gel composition to produce a reinforced aerogel composite; heating the reinforced aerogel composite to temperatures between 500° C. and 700° C. treatment in a reduced oxygen or air atmosphere; and mechanically compressing the aerogel composite under about 500 psi to about 10,000 psi, thereby preparing the non-flexible composite insulation material. In some embodiments, the sol-gel solution comprises TEOS and/or MTES. In some embodiments, the reduced oxygen atmosphere comprises less than 5% oxygen by volume. In some embodiments, the drying step comprises carbon dioxide. In some embodiments, the sol-gel solution is combined with a well-dispersed opacifying compound.

The above aspects can include one or more of the following features. In some embodiments, the fibrous material comprises discrete fibers, woven materials, non-woven materials, a mat, a felt, a batting, a lofty batting, chopped fibers, or a combination thereof. In one embodiment, almost all or portions of the fibrous material is aligned perpendicular to thickness direction of the non-flexible composite insulation material. In another embodiment, almost all or portions of the fibrous material is aligned parallel to thickness direction of the non-flexible composite insulation material. In one or more embodiments, the thickness direction of the non-flexible composite insulation material is z-axis direction.

In some embodiments, the metal oxide includes silica, alumina, titania, ceria, yttria, vanadia or any combination thereof. In a preferred embodiment, the metal oxide includes silica.

In one or more embodiments, the non-flexible composite insulation material is a compressed aerogel composite. In one or more embodiments, the metal oxide matrix is a compressed aerogel matrix.

In some embodiments, the opacifying compound is selected from B4C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof. In a preferred embodiment, the opacifying compound is silicon carbide. In one or more embodiments, the opacifying compound is present in a range of about 40 weight % to about 60 weight % relative to metal oxide content within the composite insulation material.

In some embodiments, the fibrous layer includes organic polymer-based fibers, inorganic fibers, carbon-based fibers or a combination thereof. In some embodiments, the inorganic fibers are selected from glass fibers, rock fibers, metal fibers, boron fibers, ceramic fibers, basalt fibers, or combination thereof. In a preferred embodiment, the inorganic fiber includes a glass fiber. In a more preferred embodiment, the glass fiber is a silica-based glass fiber.

In some embodiments, the polymeric binder includes polyvinyl alcohol.

In one or more embodiments, the non-flexible composite insulation material has an average thickness of less than 10 mm and a thickness variation of less than 10%.

In one or more embodiments, the non-flexible composite insulation material has a thermal conductivity of about 60 mW/m-K or less at 600° C.

In one or more embodiments, the non-flexible composite insulation material has a density in the range of about 0.20 g/cc to about 1.0 g/cc.

In one or more embodiments, the non-flexible composite insulation material has a flexural modulus in the range of about 10,000 psi to about 100,000 psi.

In one or more embodiments, the composite material substantially lacks organic moieties.

The above aspects of the present technology can include one or more of the following features. One or more of the materials of the present technology can advantageously provide a low thermal conductivity, rigid composite insulation material with improved handleability. Composite insulation material disclosed herein may be used to keep heat inside a closed system, keep heat out of a closed system or minimize heat losses in or out in partially closed systems. Such rigid composite insulation materials are useful for use in thermal batteries and the like. Specifically, the rigid composite material disclosed herein can be used as an end cap material for thermal batteries.

The non-flexible composite material disclosed herein is capable of meeting the mechanical requirements of thermal battery design yet provides superior thermal conductivity compared to incumbent technologies. In addition, the thickness of the composite material provided herein allows effective thermal management for both smaller size and larger size thermal batteries where insulation volume requirements are highly restricted.

### BRIEF DESCRIPTION OF THE DRAWINGS

The invention will be more fully understood from the following detailed description taken in conjunction with the accompanying drawings, in which:

FIG. 1A schematically illustrates a composite insulation material of the present technology.

FIG. 1B schematically illustrates a composite insulation material of the present technology.

FIG. 2A shows a flexible insulation material that can wrap around the cell stack to insulate the cell stack axially.

FIG. 2B schematically illustrates a battery casing comprising a flexible insulation material.

FIG. 3A shows an image of the non-flexible composite insulation material of the present disclosure.

FIG. 3B schematically illustrates the end cap(s) of the battery casing including the non-flexible composite insulation material of the present disclosure.

FIG. 4 illustrates compressive stress-strain curves for non-flexible composite insulation materials of the present technology against incumbent refractory ceramic end cap insulations, RS-DR and RS-200, available from ZIRCAR Refractory Composites, Inc.

FIG. 5 illustrates thermal conductivity curves of non-flexible composite insulation materials of the present technology for prototype build and testing.

### DETAILED DESCRIPTION

In one general aspect, the present disclosure provides aerogel compositions, e.g., reinforced aerogel composites, that are durable and easy to handle, which have favorable thermal properties e.g. low thermal conductivity, resistance to heat propagation and fire propagation, while minimizing thickness and weight of materials used, and that also have favorable properties for compressibility, compressional resilience, and compliance. In another general aspect, aerogel compositions provided herein are suitable for undergoing a heat treatment such as calcination and/or compression to obtain composite insulation materials of the present disclosure.

According to embodiments presented herein, improved composite insulation materials with exceptionally low thermal conductivity, good mechanical integrity and easy handleability can be prepared upon compression of aerogel composites described herein. Without wishing to be bound by any theory, this may be largely due to the finding that aerogel composites can retain or increase insubstantial amounts in thermal conductivity (commonly measured in mW/m-k) upon compression, particularly via mechanical means.

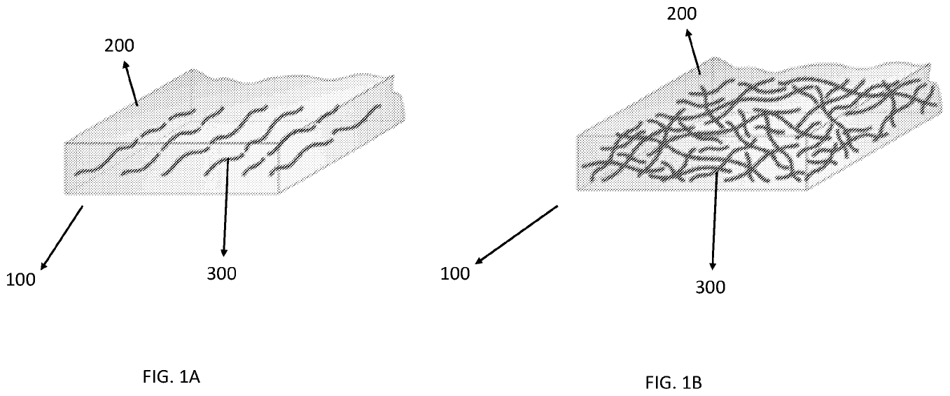

In another aspect, improved composite insulation materials for safety of thermal batteries can be prepared upon calcination of aerogel composites or compressed aerogel composites described herein. Organic moieties can be removed by calcination for improving safety of the thermal batteries since during the operation if the organic moieties were still present, they could pose a risk to the safety and performance of the battery when the organic moieties decompose and the decomposition products build up inside of a closed system. According to the embodiments described herein, the composite insulation material of the present technology is substantially free from organic moieties. FIG. 1A and FIG. 1B show a composite insulation material 100 of the present disclosure comprising a metal oxide matrix 200 reinforced with a fibrous material 300. In FIG. 1A, almost all or portions of the fibrous material 300 is aligned perpendicular to thickness direction of the non-flexible composite insulation material 100, wherein the thickness direction of the non-flexible composite insulation material 100 is the z-axis direction. In FIG. 1B, almost all or portions of the fibrous material 300 is aligned randomly (e.g. (multidirectional fiber orientation angle) within the metal oxide matrix 200.

Aerogels and aerogel composites suitable for compression and/or calcination can take on a variety of forms including particle-reinforced, fiber-reinforced or unreinforced aerogels, any one of which comprising an organic, inorganic or a hybrid aerogel matrix. A preferred form comprises a reinforcing material e.g. fibrous material. Preferably fibrous material is dispersed throughout an aerogel matrix. In a simple form of fiber-reinforced aerogel composites, a fibrous material is embedded within a matrix material for a variety of reasons, such as improved mechanical performance. The matrix material, can be prepared via sol-gel processing, resulting in a polymeric network (comprising an inorganic, organic, or inorganic/organic hybrid) that defines a structure with very small pores (on the order of billionths of a meter). Fibrous materials added prior to the point of polymeric gelation during sol-gel processing reinforce the matrix material. The aerogel matrix of the preferred precursor materials for the present invention may be organic, inorganic, or a mixture thereof. The wet gels used to prepare the aerogels may be prepared via any of the gel-forming techniques that are well-known to those skilled in the art: examples include adjusting the pH and/or temperature of a dilute metal oxide sol to a point where gelation occurs (R. K. Iler, Colloid Chemistry of Silica and Silicates, 1954, chapter 6; R. K. Iler, The Chemistry of Silica, 1979, chapter 5, C. J. Brinker and G. W. Scherer, Sol-Gel Science, 1990, chapters 2 and 3, which is incorporated by reference herein). Examples of materials for forming inorganic aerogels are metal oxides such as silica, alumina, titania, zirconia, hafnia, yttria, vanadia and the like. Particularly preferred gels are formed primarily from alcohol solutions of hydrolyzed silicate esters due to their ready availability and low cost.

According to embodiments of the present disclosure, non-flexible composite insulation materials can be obtained by exposing fiber-reinforced aerogel composites to a heat treatment in a reduced oxygen or air atmosphere; and mechanically compressing the aerogel composite.

In some examples, incorporating the non-flexible composite insulation material provided herein into a thermal battery and the like results in an improved battery performance and operational time for the thermal battery.

### Definitions of Standard Language

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means±5% of the numerical. In an embodiment, the term “about” can include traditional rounding according to significant figures of the numerical value. In addition, the phrase “about ‘x’ to ‘y’” includes “about ‘x’ to about ‘y’”.

As used herein, the term “insulation material” refers to a material that reduces heat flow to an environment e.g. a metal battery container. It will also be understood that when an element, such as a layer, region, or substrate is referred to as being “on” or “over” another element, it can be directly on the other element or intervening elements may also be present. In contrast, when an element is referred to as being “directly on” or “directly over” another element, there are no intervening elements present.

As used herein, the terms “composition” and “composite” are used interchangeably.

Aerogels are a class of porous materials with open-cells comprising a framework of interconnected structures, with a corresponding network of pores integrated within the framework, and an interstitial phase within the network of pores primarily comprised of gases such as air. Aerogels are typically characterized by a low density, a high porosity, a large surface area, and small pore sizes. Aerogels can be distinguished from other porous materials by their physical and structural properties.

Within the context of the present disclosure, the term “aerogel”, “aerogel material” or “aerogel matrix” refers to a gel comprising a framework of interconnected structures, with a corresponding network of interconnected pores integrated within the framework, and containing gases such as air as a dispersed interstitial medium; and which is characterized by the following physical and structural properties (according to Nitrogen Porosimetry Testing) attributable to aerogels: (a) an average pore diameter ranging from about 2 nm to about 100 nm, (b) a porosity of at least 80% or more, and (c) a surface area of about 100 m²/g or more.

Aerogel materials of the present disclosure thus include any aerogels or other open-celled materials which satisfy the defining elements set forth in previous paragraphs; including materials which can be otherwise categorized as xerogels, cryogels, ambigels, microporous materials, and the like.

Aerogel materials may also be further characterized by additional physical properties, including: (d) a pore volume of about 2.0 mL/g or more, particularly about 3.0 mL/g or more; (e) a density of about 0.50 g/cc or less, particularly about 0.3 g/cc or less, more particularly about 0.20 g/cc or less; and (f) at least 50% of the total pore volume comprising pores having a pore diameter of between 2 and 50 nm. However, satisfaction of these additional properties is not required for the characterization of a compound as an aerogel material.

As used herein, the term “calcination” refers to a thermal treatment process applied to materials in order to bring about a chemical, physical, or structural change in the material, but may also refer to thermal decomposition, phase transition, or removal of a volatile fraction in a material. The calcination process normally takes place at temperatures below the melting point of the product materials.

Within the context of the present disclosure, the term “aerogel composition” or “aerogel composite” refers to any composite material that includes aerogel material as a component of the composite. Examples of aerogel compositions include, but are not limited to fiber-reinforced aerogel composites; aerogel composites which include additive elements such as opacifiers; aerogel composites reinforced by open-cell macroporous frameworks; aerogel-polymer composites; and composite materials which incorporate aerogel particulates, particles, granules, beads, or powders into a solid or semi-solid material, such as in conjunction with binders, resins, cements, foams, polymers, or similar solid materials. Aerogel compositions are generally obtained after the removal of the solvent from various gel materials disclosed herein. Aerogel compositions thus obtained may further be subjected to additional processing or treatment. The various gel materials may also be subjected to additional processing or treatment otherwise known or useful in the art before subjected to solvent removal (or liquid extraction or drying).

Aerogel compositions of the present disclosure may comprise reinforced aerogel compositions. Within the context of the present disclosure, the term “reinforced aerogel composition” refers to aerogel compositions comprising a reinforcing phase within the aerogel material, where the reinforcing phase is not part of the aerogel framework itself. The reinforcing phase may be any material that provides resilience, conformability, or structural stability to the aerogel material. Examples of well-known reinforcing materials include, but are not limited to open-cell macroporous framework reinforcement materials, closed-cell macroporous framework reinforcement materials, open-cell membranes, honeycomb reinforcement materials, polymeric reinforcement materials, and fiber reinforcement materials such as discrete fibers, woven materials, non-woven materials, needled non-wovens, battings, webs, mats, and felts.

Within the context of the present disclosure, the term “fiber-reinforced aerogel composition” refers to a reinforced aerogel composition which comprises a fiber reinforcement material as a reinforcing phase. Examples of fiber reinforcement materials include, but are not limited to, discrete fibers, woven materials, non-woven materials, batts, battings, webs, mats, felts, or combinations thereof. Fiber reinforcement materials can comprise a range of materials, including, but not limited to: Polyesters, polyolefin terephthalates, poly(ethylene) naphthalate, polycarbonates (examples Rayon, Nylon), cotton, (e.g. lycra manufactured by DuPont), carbon (e.g. graphite), polyacrylonitriles (PAN), oxidized PAN, uncarbonized heat treated PANs (such as those manufactured by SGL carbon SE, Germany), glass or fiberglass based material (like S-glass, 901 glass, 902 glass, 475 glass, E-glass) silica based fibers like quartz, (e.g. Quartzel manufactured by Saint-Gobain), Q-felt (manufactured by Johns Manville), Saffil (manufactured by Unifrax), Durablanket (manufactured by Unifrax) and other silica fibers, Duraback (manufactured by Carborundum), Polyaramid fibers like Kevlar, Nomex, Sontera (all manufactured by DuPont), Conex (manufactured by Taijin), polyolefins like Tyvek (manufactured by DuPont), Dyneema (manufactured by DSM), Spectra (manufactured by Honeywell), other polypropylene fibers like Typar, Xavan (both manufactured by DuPont), fluoropolymers like PTFE with trade names as Teflon (manufactured by DuPont), Goretex (manufactured by W.L. GORE), silicon carbide fibers like Nicalon (manufactured by COI Ceramics), ceramic fibers like Nextel (manufactured by 3M), acrylic polymers, fibers of wool, silk, hemp, leather, suede, PBO-Zylon fibers (manufactured by Tyobo), liquid crystal material like Vectan (manufactured by Hoechst), Cambrelle fiber (manufactured by DuPont), polyurethanes, polyamaides, wood fibers, boron, aluminum, iron, stainless steel fibers and other thermoplastics like PEEK, PES, PEI, PEK, PPS. The glass or fiberglass-based fiber reinforcement materials may be manufactured using one or more techniques. In certain embodiments, it is desirable to make them using a carding and cross-lapping or air-laid process. In exemplary embodiments, carded and cross-lapped glass or fiberglass-based fiber reinforcement materials provide certain advantages over air-laid materials. For example, carded and cross-lapped glass or fiberglass-based fiber reinforcement materials can provide a consistent material thickness for a given basis weight of reinforcement material. In certain additional embodiments, it is desirable to further needle the fiber reinforcement materials with a need to interlace the fibers in z-direction for enhanced mechanical and other properties in the final aerogel composition.

Within the context of the present disclosure, the term “binder” or “binding agent” is any material or substance that holds or draws other materials together to form a cohesive whole mechanically, chemically, by adhesion or cohesion.

As used herein, the terms “compress,” “compressed,” “compression” and other grammatical forms thereof will refer to the act of applying pressure to a structure, particularly a mechanical force that decreases the volume of the structure and increases its density. As used herein, the term “compressed aerogel matrix” refers to an as-produced aerogel matrix that has been decreased in volume by application of a compressive force thereto. Compressive forces can include, but are not limited to, squeezing, compacting in a hydraulic press, rolling, and the like. Compression forces can be parallel or orthogonal to the predominant direction of the fibers dispersed within the aerogel matrix.

Compressed aerogels and aerogel composites can display higher compressive strength, modulus, flexural strength, and maintain or insubstantially increase the thermal conductivity relative to the uncompressed form. Without wishing to be bound by any theory, subsequent to compression, the pore size distribution of aerogels is typically narrowed and lowered by a significant amount. Despite such occurrence, the high surface areas of aerogels may be essentially unaffected by compression with improved or substantially unchanged thermal conductivity (within certain compression ranges e.g. between about 500 psi to about 10,000 psi).

Aerogels and aerogel composites suitable for compression can take on a variety of forms including particle-reinforced, fiber-reinforced or unreinforced aerogels, any one of which comprising an organic, inorganic or a hybrid aerogel matrix. A preferred form is a two phase aerogel composite where the first phase comprises a low-density aerogel matrix and the second comprises a reinforcing material e.g. a fibrous material.

The term “flexural modulus” or “bending modulus of elasticity” is a measure of a materials stiffness/resistance to bend when a force is applied perpendicular to the long edge of a sample-known as the three-point bend test. Flexural Modulus denotes the ability of a material to bend. The flexural modulus is represented by the slope of the initial straight line portion of the stress-strain curve and is calculated by dividing the change in stress by the corresponding change in strain. Hence, the ratio of stress to strain is a measure of the flexural modulus. The International Standard unit of Flexural Modulus is the pascal (Pa or N/m2 or m−1·kg·s−2). The practical units used are megapascals (MPa or N/mm2) or gigapascals (GPa or kN/mm2). In the US customary units, it is expressed as pounds (force) per square inch (psi).

Within the context of the present disclosure, the terms “non-flexible” or “rigid” refer to materials which do not have the ability or have limited ability to be bent or flexed without macrostructural failure. Non-flexible insulation materials of the present disclosure have a flexural modulus in the range of about 10,000 psi to about 100,000 psi.

Within the context of the present disclosure, the terms “additive” or “additive element” refer to materials that may be added to an aerogel composition before, during, or after the production of the aerogel. Additives may be added to alter or improve desirable properties in an aerogel, or to counteract undesirable properties in an aerogel. Additives are typically added to an aerogel material either prior to gelation to precursor liquid, during gelation to a transition state material or after gelation to a solid or semi solid material. Examples of additives include, but are not limited to microfibers, fillers, reinforcing agents, stabilizers, thickeners, elastic compounds, opacifiers, coloring or pigmentation compounds, radiation absorbing compounds, radiation reflecting compounds, fire-class additives, corrosion inhibitors, thermally conductive components, components providing thermal capacitance, phase change materials, pH adjustors, redox adjustors, HCN mitigators, off-gas mitigators, electrically conductive compounds, electrically dielectric compounds, magnetic compounds, radar blocking components, hardeners, anti-shrinking agents, and other aerogel additives known to those in the art.

In certain embodiments, the insulation composite materials provided herein can perform during high temperature events, e.g., provide thermal protection during high temperature events as disclosed herein. High temperature events are characterized by a sustained heat flux of at least about 25 kW/m², at least about 30 kW/m², at least about 35 kW/m² or at least about 40 kW/m² over an area of at least about 1 cm² for at least 2 seconds. A heat flux of about 40 kW/m² has been associated with that arising from typical fires (Behavior of Charring Solids under Fire-Level Heat Fluxes; Milosavljevic, I., Suuberg, E. M.; NISTIR 5499; September 1994). In a special case, the high temperature event is a heat flux of about 40 kW/m over an area of at least about 10 cm² for a duration of at least 1 minute.

Within the context of the present disclosure, the terms “thermal conductivity” and “TC” refer to a measurement of the ability of a material or composition to transfer heat between two surfaces on either side of the material or composition, with a temperature difference between the two surfaces. Thermal conductivity is specifically measured as the heat energy transferred per unit time and per unit surface area, divided by the temperature difference. It is typically recorded in SI units as mW/m*K (milliwatts per meter*Kelvin). The thermal conductivity of a material may be determined by test methods known in the art, including, but not limited to Test Method for Steady-State Thermal Transmission Properties by Means of the Heat Flow Meter Apparatus (ASTM C518, ASTM International, West Conshohocken, PA); a Test Method for Steady-State Heat Flux Measurements and Thermal Transmission Properties by Means of the Guarded-Hot-Plate Apparatus (ASTM C177, ASTM International, West Conshohocken, PA); a Test Method for Steady-State Heat Transfer Properties of Pipe Insulation (ASTM C335, ASTM International, West Conshohocken, PA); a Thin Heater Thermal Conductivity Test (ASTM C1114, ASTM International, West Conshohocken, PA); Standard Test Method for Thermal Transmission Properties of Thermally Conductive Electrical Insulation Materials (ASTM D5470, ASTM International, West Conshohocken, PA); Determination of thermal resistance by means of guarded hot plate and heat flow meter methods (EN 12667, British Standards Institution, United Kingdom); or Determination of steady-state thermal resistance and related properties-Guarded hot plate apparatus (ISO 8203, International Organization for Standardization, Switzerland). Due to different methods possibly resulting in different results, it should be understood that within the context of the present disclosure and unless expressly stated otherwise, thermal conductivity measurements are acquired according to ASTM C518 standard (Test Method for Steady-State Thermal Transmission Properties by Means of the Heat Flow Meter Apparatus), at a temperature of about 37.5° C. at atmospheric pressure in ambient environment, and under a compression load of about 2 psi. The measurements reported as per ASTM C518 typically correlate well with any measurements made as per EN 12667 with any relevant adjustment to the compression load. In certain embodiments, aerogel materials or non-flexible composite insulation materials of the present disclosure have a thermal conductivity of about 40 mW/mK or less, about 30 mW/mK or less, about 25 mW/mK or less, about 20 mW/mK or less, about 18 mW/mK or less, about 16 mW/mK or less, about 14 mW/mK or less, about 12 mW/mK or less, about 10 mW/mK or less, about 5 mW/mK or less, or in a range between any two of these values. In certain embodiments, aerogel materials or non-flexible composite insulation materials of the present disclosure have a thermal conductivity of about 60 mW/mK or less at 600° C.

Within the context of the present disclosure, the term “density” refers to a measurement of the mass per unit volume of an aerogel material or composition. The term “density” generally refers to the apparent density of an aerogel material, as well as the bulk density of an aerogel composition. Density is typically recorded as kg/m³ or g/cc. The density of an aerogel material or composition may be determined by methods known in the art, including, but not limited to Standard Test Method for Dimensions and Density of Preformed Block and Board-Type Thermal Insulation (ASTM C303, ASTM International, West Conshohocken, PA); Standard Test Methods for Thickness and Density of Blanket or Batt Thermal Insulations (ASTM C167, ASTM International, West Conshohocken, PA); Determination of the apparent density of preformed pipe insulation (EN 13470, British Standards Institution, United Kingdom); or Determination of the apparent density of preformed pipe insulation (ISO 18098, International Organization for Standardization, Switzerland). Due to different methods possibly resulting in different results, it should be understood that within the context of the present disclosure, density measurements are acquired according to ASTM C167 standard (Standard Test Methods for Thickness and Density of Blanket or Batt Thermal Insulations) at 2 psi compression for thickness measurement, unless otherwise stated. In certain embodiments, non-flexible composite insulation materials of the present disclosure have a density in the range of about 0.20 g/cc to about 1.2 g/cc, specifically in the range of about 0.20 g/cc to about 0.80 g/cc, more specifically in the range of about 0.20 g/cc to about 0.60 g/cc.

As used herein, the term “substantially” refers to a quantitative state that indicates a complete or near complete degree or degree of a feature or characteristic of interest. As used herein, the term “substantially free” means that the analyte, the sample, solution, media, supplement, excipient and the like, is at least 85%, at least 90%, at least 95%, at least 98%, or at least 98.5%, or at least 99%, or at least 99.5%, or at least 100% free of interference compounds, impurities, contaminants or equivalent thereof.

As used herein, the term “almost all” refers to 80% or more, preferably 85% or more, more preferably 90% or more, still more preferably 95% or more, and most preferably 99% or more.

For optimal thermal insulation, aerogels or the composite insulation material of the present disclosure can be opacified to reduce the radiative component of heat transfer. At any point prior to gel formation, opacifying compounds may be dispersed into the mixture comprising gel precursors. Examples of opacifying compounds include and are not limited to: B4C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof. The opacifying compound within the composite insulation material is present in a range of about 10 weight % to about 80 weight %, preferably in a range of about 40 weight % to about 60 weight %, relative to metal oxide content within composite insulation material.

As used herein, the term “well-dispersed” refers to the effect opacifying compound as existed in the sol-gel solution do not aggregate in bulk, and more specifically refers to opacifying compound that exist in the sol-gel solution as a single particle or fiber or as a small bundles of ≤3-4 particles or fibers per bundle.

### Aerogel Compositions

Aerogels are described as a framework of interconnected structures that are most commonly comprised of interconnected oligomers, polymers, or colloidal particles. An aerogel framework may be made from a range of precursor materials, including inorganic precursor materials (such as precursors used in producing silica-based aerogels); organic precursor materials (such precursors used in producing carbon-based aerogels); hybrid inorganic/organic precursor materials; and combinations thereof.

Inorganic aerogels are generally formed from metal oxide or metal alkoxide materials. The metal oxide or metal alkoxide materials may be based on oxides or alkoxides of any metal that can form oxides. Such metals include, but are not limited to silicon, aluminum, titanium, zirconium, hafnium, yttrium, vanadium, cerium, and the like. Inorganic silica aerogels are traditionally made via the hydrolysis and condensation of silica-based alkoxides (such as tetraethoxylsilane), or via gelation of silicic acid or water glass. Other relevant inorganic precursor materials for silica based aerogel synthesis include, but are not limited to metal silicates such as sodium silicate or potassium silicate, alkoxysilanes, partially hydrolyzed alkoxysilanes, tetraethoxylsilane (TEOS), partially hydrolyzed TEOS, condensed polymers of TEOS, tetramethoxylsilane (TMOS), partially hydrolyzed TMOS, condensed polymers of TMOS, tetra-n-propoxysilane, partially hydrolyzed and/or condensed polymers of tetra-n-propoxysilane, polyethylsilicates, partially hydrolyzed polyethysilicates, monomeric alkylalkoxy silanes, bis-trialkoxy alkyl or aryl silanes, polyhedral silsesquioxanes, or combinations thereof.

In certain embodiments of the present disclosure, pre-hydrolyzed TEOS, such as Silbond H-5 (SBH5, Silbond Corp) may be used as commercially available or may be further hydrolyzed prior to incorporation into the gelling process. Partially hydrolyzed TEOS or TMOS, such as polyethysilicate (Silbond 40) or polymethylsilicate may also be used as commercially available or may be further hydrolyzed prior to incorporation into the gelling process.

Inorganic aerogels can also include gel precursors comprising at least one hydrophobic group, such as alkyl metal alkoxides, cycloalkyl metal alkoxides, and aryl metal alkoxides, which can impart or improve certain properties in the gel such as stability and hydrophobicity. Inorganic silica aerogels can specifically include hydrophobic precursors such as alkylsilanes or arylsilanes. Hydrophobic gel precursors may be used as primary precursor materials to form the framework of a gel material. However, hydrophobic gel precursors are more commonly used as co-precursors in combination with simple metal alkoxides in the formation of amalgam aerogels. Hydrophobic inorganic precursor materials for silica based aerogel synthesis include, but are not limited to trimethyl methoxysilane (TMS), dimethyl dimethoxysilane (DMS), methyl trimethoxysilane (MTMS), trimethyl ethoxysilane, dimethyl diethoxysilane (DMDS), methyl triethoxysilane (MTES), ethyl triethoxysilane (ETES), diethyl diethoxysilane, dimethyl diethoxysilane (DMDES), ethyl triethoxysilane, propyl trimethoxysilane, propyl triethoxysilane, phenyl trimethoxysilane, phenyl triethoxysilane (PhTES), hexamethyldisilazane and hexaethyldisilazane, and the like. Any derivatives of any of the above precursors may be used and specifically certain polymeric of other chemical groups may be added or cross-linked to one or more of the above precursors.

Organic aerogels are generally formed from carbon-based polymeric precursors. Such polymeric materials include, but are not limited to resorcinol formaldehydes (RF), polyimide, polyacrylate, polymethyl methacrylate, acrylate oligomers, polyoxyalkylene, polyurethane, polyphenol, polybutadiane, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations thereof. As one example, organic RF aerogels are typically made from the sol-gel polymerization of resorcinol or melamine with formaldehyde under alkaline conditions.

Organic/inorganic hybrid aerogels are mainly comprised of (organically modified silica (“ormosil”) aerogels. These ormosil materials include organic components that are covalently bonded to a silica network. Ormosils are typically formed through the hydrolysis and condensation of organically modified silanes, R—Si(OX)₃, with traditional alkoxide precursors, Y(OX)₄. In these formulas, X may represent, for example, CH₃, C₂H₅, C₃H₇, C₄H₉; Y may represent, for example, Si, Ti, Zr, or Al; and R may be any organic fragment such as methyl, ethyl, propyl, butyl, isopropyl, methacrylate, acrylate, vinyl, epoxide, and the like. The organic components in ormosil aerogel may also be dispersed throughout or chemically bonded to the silica network.

### Method of Preparation of Aerogels

Preparation of an aerogel generally includes the following steps: i) formation of a sol-gel solution; ii) formation of a gel from the sol-gel solution; and iii) extracting the solvent from the gel materials through innovative processing and extraction, to obtain a dried aerogel material. This process is discussed below in greater detail, specifically in the context of forming inorganic aerogels such as silica aerogels. However, the specific examples and illustrations provided herein are not intended to limit the present disclosure to any specific type of aerogel and/or method of preparation. The present disclosure can include any aerogel formed by any associated method of preparation known to those in the art, unless otherwise noted.

The first step in forming an inorganic aerogel is generally the formation of a sol-gel solution through hydrolysis and condensation of silica precursors, such as, but not limited to, metal alkoxide precursors in an alcohol-based solvent. Major variables in the formation of inorganic aerogels include the type of alkoxide precursors included in the sol-gel solution, the nature of the solvent, the processing temperature and pH of the sol-gel solution (which may be altered by addition of an acid or a base), and precursor/solvent/water ratio within the sol-gel solution. Control of these variables in forming a sol-gel solution can permit control of the growth and aggregation of the gel framework during the subsequent transition of the gel material from the “sol” state to the “gel” state. While properties of the resulting aerogels are affected by the pH of the precursor solution and the molar ratio of the reactants, any pH and any molar ratios that permit the formation of gels may be used in the present disclosure.

A sol-gel solution is formed by combining at least one gelling precursor with a solvent. Suitable solvents for use in forming a sol-gel solution include lower alcohols with 1 to 6 carbon atoms, particularly 2 to 4, although other solvents can be used as known to those with skill in the art. Examples of useful solvents include, but are not limited to methanol, ethanol, isopropanol, ethyl acetate, ethyl acetoacetate, acetone, dichloromethane, tetrahydrofuran, and the like. Multiple solvents can also be combined to achieve a desired level of dispersion or to optimize properties of the gel material. Selection of optimal solvents for the sol-gel and gel formation steps thus depends on the specific precursors, fillers, and additives being incorporated into the sol-gel solution; as well as the target processing conditions for gelling and liquid extraction, and the desired properties of the final aerogel materials.

Water can also be present in the precursor-solvent solution. The water acts to hydrolyze the metal alkoxide precursors into metal hydroxide precursors. The hydrolysis reaction can be (using TEOS in ethanol solvent as an example): Si(OC₂H₅)₄+4H₂O→Si(OH)₄+4(C₂H₅OH). The resulting hydrolyzed metal hydroxide precursors remain suspended in the solvent solution in a “sol” state, either as individual molecules or as small polymerized (or oligomarized) colloidal clusters of molecules. For example, polymerization/condensation of the Si(OH)₄ precursors can occur as follows: 2 Si(OH)₄=(OH)₃Si—O—Si(OH)₃+H₂O. This polymerization can continue until colloidal clusters of polymerized (or oligomarized) SiO₂ (silica) molecules are formed.

Acids and bases can be incorporated into the sol-gel solution to control the pH of the solution, and to catalyze the hydrolysis and condensation reactions of the precursor materials. While any acid may be used to catalyze precursor reactions and to obtain a lower pH solution, exemplary acids include HCl, H₂SO₄, H₃PO₄, oxalic acid and acetic acid. Any base may likewise be used to catalyze precursor reactions and to obtain a higher pH solution, with an exemplary base comprising NH₄OH.

Strong bases may be used to catalyze precursor reactions and obtain a higher pH solution. The use of a strong base to catalyze precursor reactions can enable the content of hydrophobic inorganic precursor materials, e.g., MTES or DMDES, to be significantly higher than would be possible using a weak base, e.g., a base comprising NH₄OH. Within the context of the present disclosure, the term “strong base” refers to both inorganic and organic bases. For example, strong bases according to embodiments herein include cations selected from the group consisting of lithium, calcium, sodium, potassium, rubidium, barium, strontium, and guanidinium. For another example, the basic catalyst used to catalyze precursor reactions can include a catalytic amount of sodium hydroxide, lithium hydroxide, calcium hydroxide, potassium hydroxide, strontium hydroxide, barium hydroxide, guanidine hydroxide, sodium hydroxide, tetrabutylammonium hydroxide, tetramethylammonium hydroxide, choline hydroxide, phosphonium hydroxide, DABCO, DBU, guanidine derivatives, amidines, or phosphazenes.

Aerogel compositions of the present disclosure can have a thickness of 15 mm or less, 10 mm or less, 5 mm or less, 4 mm or less, 3 mm or less, 2 mm or less, 1 mm or less, 0.5 mm or less, 0.3 mm or less, or ranges of thicknesses between any combination of the aforementioned thicknesses.

Aerogel compositions may be reinforced with various reinforcement materials to achieve a more resilient composite product. The reinforcement materials can be added to the gels at any point in the gelling process to produce a wet, reinforced gel composition. The wet gel composition may then be dried to produce a reinforced aerogel composition.

Aerogel compositions can include an opacifier to reduce the radiative component of heat transfer. At any point prior to gel formation, opacifying compounds or precursors thereof may be dispersed into the mixture comprising gel precursors. Examples of opacifying compounds include, but are not limited to Boron Carbide (B₄C), Diatomite, Manganese ferrite, MnO, NiO, SnO, Ag₂O, Bi₂O₃, carbon black, graphite, titanium oxide, iron titanium oxide, aluminum oxide, zirconium silicate, zirconium oxide, iron (II) oxide, iron (III) oxide, manganese dioxide, iron titanium oxide (ilmenite), chromium oxide, carbides (such as SiC, TiC or WC), or mixtures thereof. Examples of opacifying compound precursors include, but are not limited to TiOSO₄ or TiOCl₂. In some embodiments, the opacifying compounds used as additives can exclude whiskers or fibers of silicon carbide. When aerogel compositions are intended for use in electrical devices, e.g., in batteries as a barrier layer or other related applications, the composition including an opacifier can desirably possess a high dielectric strength with high volume and surface resistivities. In such embodiments, carbon additives used as an opacifier can be non-conductive or modified to reduce electrical conductivity. For example, the opacifier can be surface oxidized to reduce electrical conductivity. In some embodiments, carbonaceous additives with inherent electrical conductivity can be used as an opacifier in aerogel compositions intended for used in electrical devices. In such embodiments, the conductive carbonaceous additives can be used at concentrations below the percolation threshold so as to provide a composition with a suitable dielectric strength for use in an electrical device.

Aerogel compositions can include one or more fire-class additives. Within the context of the present disclosure, the term “fire-class additive” refers to a material that has an endothermic effect in the context of reaction to fire and can be incorporated into an aerogel composition. Furthermore, in certain embodiments, fire-class additives have an onset of endothermic decomposition (ED) that is no more than 100° C. greater than the onset of thermal decomposition (Ta) of the aerogel composition in which the fire-class additive is present, and in certain embodiments, also an ED that is no more than 50° C. lower than the T_{d} of the aerogel composition in which the fire-class additive is present. In other words, the ED of fire-class additives has a range of (T_{d}−50° C.) to (T_{d}+100° C.):

$${E}_{D} \{ \begin{matrix}max : {T}_{d} + 100 °C \\ min : {T}_{d} - 50 °C\end{matrix}$$

Prior to, concurrent with, or even subsequent to incorporation or mixing with the sol (e.g., silica sol prepared from alkyl silicates or water glass in various ways as understood in prior art), fire-class additives can be mixed with or otherwise dispersed into a medium including ethanol and optionally up to 10% vol. water. The mixture may be mixed and/or agitated as necessary to achieve a substantially uniform dispersion of additives in the medium. Without being bound by theory, utilizing a hydrated form of the above-referenced clays and other fire-class additives provides an additional endothermic effect. For example, halloysite clay (commercially available under the tradename DRAGONITE from Applied Minerals, Inc. or from Imerys simply as Halloysite), kaolinite clay are aluminum silicate clays that in hydrated form has an endothermic effect by releasing water of hydration at elevated temperatures (gas dilution). As another example, carbonates in hydrated form can release carbon dioxide on heating or at elevated temperatures.

When referring to the final reinforced aerogel compositions, the amount of additives is typically referred to as a weight percentage of the final reinforced aerogel composition. The amount of additives in the final reinforced aerogel composition may vary from about 1% to about 50%, about 1% to about 25%, or about 10% to about 25% by weight of the reinforced aerogel composition. In exemplary embodiments, the amount of additives in the final reinforced aerogel composition is in the range of about 10% to about 20% by weight of the reinforced aerogel composition. In exemplary embodiments, the amount of additives in the final reinforced aerogel composition as a weight percentage of the composition is about 1%, about 2% about 3%, about 4%, about 5%, about 6%, about 7%, about 8%, about 9%, about 10%, about 11%, about 12%, about 13%, about 14%, about 15%, about 16%, about 17%, about 18%, about 19% about 20% or in a range between any of the aforementioned percentages. In certain embodiments, the amount of additives in the final reinforced aerogel composition is about 15% by weight of the reinforced aerogel composition. In certain embodiments, the amount of additives in the final reinforced aerogel composition is about 13% by weight of the reinforced aerogel composition. For example, in some preferred embodiments which include additives such as silicon carbide, the total amount of additives present in the aerogel compositions is about 10-20%, e.g., about 15%, by weight of the reinforced aerogel composition. For another example, in some preferred embodiments in which additives include silicon carbide, the total amount of additives present in the aerogel compositions is about 3-5%, e.g., about 4%, by weight of the reinforced aerogel composition.

### Composite Insulation Material and Preparation Thereof

Provided herein is a non-flexible composite insulation material comprising a metal oxide matrix (e.g. an aerogel matrix), an opacifying compound, and a fibrous material optionally comprising a polymeric binder, wherein the non-flexible composite insulation material is reinforced with the fibrous material.

The composite insulation materials disclosed herein were optimized according to density, aerogel-fiber ratio, additive content and aerogel chemistry to improve safety of any type of reserve batteries (e.g., thermal batteries, liquid oxyhalide batteries).

The amount of additives in the non-flexible composite insulation material may vary from about 40% to about 80%, about 40% to about 70%, or about 40% to about 60% by weight of the metal oxide content within the composite insulation material. In exemplary embodiments, the amount of additives in the non-flexible composite insulation material as a weight percentage of the metal oxide content is about 40%, about 45% about 50%, about 55%, about 60%, about 65%, about 70%, about 75%, about 80% or in a range between any of the aforementioned percentages. For example, in some preferred embodiments which include additives such as silicon carbide, the total amount of additives present in the non-flexible composite insulation material is about 40% by weight of the metal oxide matrix. In certain embodiments, the additives may be of more than one type. One or more fire-class additives may also be present in the non-flexible composite insulation material. In some preferred embodiments which include aluminum silicate fire-class additives, the additives are present in the non-flexible composite insulation material in about 60-80 wt % relative to metal oxide content.

The non-flexible composite insulation material typically has a density greater than about 0.20 g/cc and a flexural modulus greater than about 10,000 psi. For example, density of the non-flexible composite insulation material can be in the range of about 0.20 g/cc to about 1.2 g/cc, specifically in the range of about 0.20 g/cc to about 0.80 g/cc, more specifically in the range of about 0.20 g/cc to about 0.60 g/cc.

Provided herein is a non-flexible composite insulation material comprising a metal oxide matrix (e.g. an aerogel matrix reinforced with a fibrous material embedded therein), wherein the fibrous material optionally comprises a polymeric binder, and wherein an opacifying compound is dispersed throughout the metal oxide matrix. In some embodiments, the non-flexible composite insulation material has a flexural modulus greater than about 10,000 psi and the opacifying compound is present at greater than about 40 weight % relative to metal oxide content within the composite insulation material.

In some embodiments, almost all or portions of the fibrous material is aligned along the x-y plane within the metal oxide matrix. In one embodiment, almost all or portions of the fibrous material is aligned perpendicular to thickness direction of the non-flexible composite insulation material. In another embodiment, almost all or portions of the fibrous material is aligned parallel to thickness direction of the non-flexible composite insulation material. In one or more embodiments, the thickness direction of the non-flexible composite insulation material is z-axis direction.

In some embodiments, almost all or portions of the fibrous material is aligned randomly within the metal oxide matrix.

The non-flexible composite insulation materials disclosed herein can be obtained by exposing fiber-reinforced aerogel composites to a heat treatment (e.g. calcination in a reduced oxygen or air atmosphere); and/or by mechanically compressing the aerogel composite. Without wishing to be bound by theory, some or all of the physicochemical and/or mechanical properties of the aerogel composites described herein may change upon heat treatment and/or compression. In some examples, porosity e.g. pore size, percentage of porosity, density, thermal conductivity and/or flexural modulus of the non-flexible composite insulation materials of the present disclosure can be different from that of fiber-reinforced aerogel composites having substantially the same composition which are not exposed to calcination and/or compression.

In some embodiments, density of the non-flexible composite insulation material is about 5 to 100 times higher than the density of the reinforced aerogel composite which is not exposed to calcination and/or compression.

In some embodiments, the thermal conductivity of the aerogel composite at 600° C. is substantially unchanged relative to an uncompressed reinforced aerogel composite having substantially the same composition.

In some embodiments, the composite insulation material of the present disclosure substantially lacks organic moieties.

In some embodiments, the composite insulation material of the present disclosure is mechanically compressed material.

In exemplary embodiments, the composite insulation material has a thickness in the range of about 0.02 mm to about 10 mm. For example, the composite material can have a thickness in the range of about 0.5 mm to about 10 mm. For another example, the composite material can have a thickness in the range of about 0.5 mm to about 5 mm. For another example, the composite material can have a thickness of about 2 mm, a thickness of about 3 mm, or a thickness of about 4 mm.

Provided herein is a method for preparing a non-flexible composite insulation material, comprising: providing a reinforced aerogel composite comprising a metal oxide matrix, an opacifying compound, and a fibrous material optionally comprising a polymeric binder; exposing the aerogel composite to a heat treatment in a reduced oxygen or air atmosphere, wherein the heat treatment comprises exposure to one or more temperatures between 500° C. and 700° C.; and mechanically compressing the aerogel composite, thereby preparing the non-flexible composite insulation material. In some embodiments, the density of the aerogel composite is increased by a factor up to 10-100.

In some embodiments, the thermal conductivity of the non-flexible composite insulation material at room temperature, 100° C., 200° C., 300° C., 400° C., 500° C., and 600° C. is substantially unchanged relative to an uncompressed reinforced aerogel composite having substantially the same composition.

In certain embodiments, the non-flexible composite insulation material of the present disclosure has an onset of thermal decomposition of about 300° C. or more, about 320° C. or more, about 340° C. or more, about 360° C. or more, about 380° C. or more, about 400° C. or more, about 420° C. or more, about 440° C. or more, about 460° C. or more, about 480° C. or more, about 500° C. or more, about 550° C. or more, about 600° C. or more, or in a range between any two of these values.

In some embodiments, the total duration of the heat treatment is between 1 minutes to 360 minutes, preferably between 1 minute to 120 minutes. In some embodiments, the heat treatment ranges from 3 minutes to 50 minutes, or from 5 minutes to 45 minutes.

In some embodiments, the aerogel composite is compressed by less than 80% in volume in order to form the composite insulation material of the present disclosure. In some embodiments, the aerogel composite is compressed under a pressure of about 1000 psi to about 10,000 psi.

Provided herein is a method of producing a non-flexible composite insulation material, comprising: providing a casting surface and a flat casting frame, wherein an inner boundary of the casting frame encloses a casting area on the casting surface; providing a sol-gel solution; placing the fibrous material into the casting area; combining the sol-gel solution with the fibrous material in the casting area; allowing the sol-gel solution to transition into a gel material, thereby forming a reinforced gel; drying the reinforced gel composition to produce a reinforced aerogel composite; heating the reinforced aerogel composite to temperatures between 300° C. and 700° C., preferably between 500° C. and 700° C., treatment in a reduced oxygen or air atmosphere; and mechanically compressing the aerogel composite under about 1000 psi to about 10,000 psi, thereby preparing the non-flexible composite insulation material. In some embodiments, the sol-gel solution comprises TEOS and/or MTES.

In some embodiments, the drying comprises supercritical fluids. In some embodiments, the drying step comprises carbon dioxide.

In some embodiments, the reduced oxygen or air atmosphere comprises 0.1% to 5% oxygen by volume.

### Use of Composite Insulation Material for Thermal Batteries

The present disclosure provides a thermal battery comprising the non-flexible composite insulation material disclosed herein.

According to multiple embodiments of the present disclosure, the performance and the operational lifetime of thermal batteries can increase by incorporating the non-flexible composite insulation material provided herein.

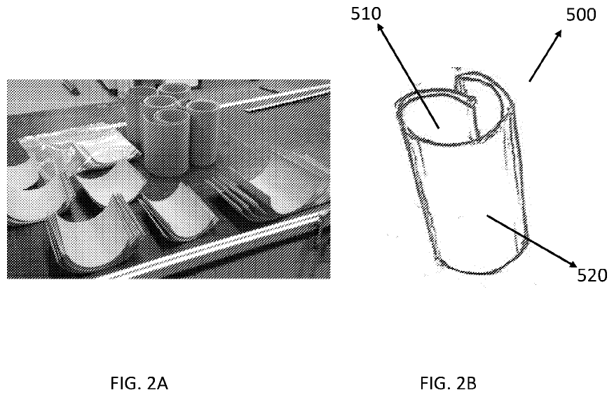

Thermal batteries include a plurality of stacked electrochemical cells within a suitable battery casing. FIG. 2B shows an illustrative battery casing 500. The battery casing houses a reserve battery, such as a thermal battery. The casing can be metal, metallic alloy or combination thereof. Non-limiting examples of suitable metals include stainless steel, titanium, titanium alloys, nickel, nickel alloys, nickel-plated steel, aluminum, aluminum alloys, copper, copper alloys, or any combination thereof. In some embodiments, the container has the form or shape of a plate, blade, grid, or panel. In some embodiments, the casing has a cylindrical form.

The thermal battery's cell stack may be insulated against heat loss by wrapping it with multiple layers of soft, flexible insulation blankets shown in FIG. 2A and FIG. 2B. The insulated cell stack is then inserted into the battery casing 500 and sealed. The insulation material of the present disclosure can line the interior surface 510, the exterior surface 520, or both interior 510 and exterior surfaces 520, of a battery casing 500 (battery container).

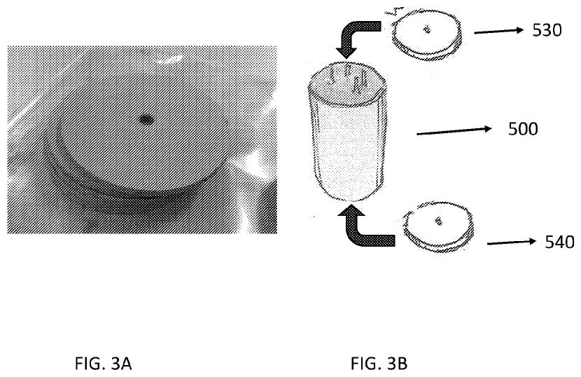

The battery casing can include an open top or a closed top. The battery containers 500 also can include an open bottom or a closed bottom. When one or more ends (top or bottom) are open, a cover can be included on the ends 530 and 540, which can include one or more metals. An exemplary rigid composite insulation material of present disclosure shown in FIG. 3A can line on one or more surfaces (interior and exterior) of the end covers.

The composite insulation material is applied as a single layer or as a multi-layer stack-up. The stack-up could employ a different density and/or composition for each layer.

The composite insulation material is applied to the battery container by any method, such as spraying, rolling, casting, or painting, which provides a hard, substantially hard, or rigid coating.

The composite insulation material can include one or more layers. The layers can be the same or different. For example, one layer can be the composite insulation material of the present technology and another layer can be a ceramic layer. The other layers can be selected from the materials having a melting point of at least about 2600° F. (1426° C.); or in a range from about 3450° to about 4980° F. (from about 1900° C. to about 2750° C.).

In addition to thermal batteries, the composite insulation materials disclosed herein is suitable for battery casings of other types of reserve batteries, for example liquid oxyhalide batteries. Various problems in liquid oxyhalide reserve batteries can be solved by the composite insulation materials disclosed herein.

Composite insulation materials according to embodiments of the present disclosure can be formed into various end products including but not limited to shapes that fit to inner end cap of thermal batteries. In the simplest configuration, the composite insulation material can be in the form of a sheet, a panel or a disk. The sheet can be formed continuously or semi-continuously, e.g., as a rolled product, or sheets of a desired size and shape can be cut or otherwise formed from a larger sheet. In some embodiments, the sheet material can be used to form an inner end cap insulation material. In some embodiments, the sheet material can be used to form a thermal barrier between battery cells. In other configurations, the composite insulation material can be formed into a pouch, e.g., to contain a pouch cell of a battery, or into a cylinder to contain cylindrical battery cells.

Composite insulation material of the present disclosure may be shaped into a range of three-dimensional forms, including paneling, pipe preforms, half-shell preforms, elbows, joints, pouches, cylinders and other shapes regularly required in the application of insulation materials to industrial and commercial applications. In one embodiment, the composite insulation material is formed into a desired shape prior to being infused with gel precursor material.

Composite insulation material of the present disclosure may have an average thickness of less than 5 mm and a thickness variation of less than 10%.

As mentioned above, the battery container, and optional end covers, can made of a metal or metal alloy. Non-limiting examples of suitable metals include stainless steel, titanium, titanium alloys, nickel, nickel alloys, nickel-plated steel, aluminum, aluminum alloys, copper, copper alloys, or any combination thereof.

### Methods/Techniques/Results

The non-flexible composite insulation material of the present disclosure has low thermal conductivity, good mechanical integrity and handleability. This composite was designed to withstand a significant amount of compressive force during installation and while in use.

The non-flexible composite insulation material of the present disclosure is designed by considering fiber type, aerogel-fiber ratio, additive content, calcination temperature, and delamination potential after compression. The materials made in accordance with the present disclosure have advantages over the present commercially available materials, such as RS-DR and Zircal-45. For example, the insulation materials of the present technology have lower thermal conductivity at 600° C. compared to RS-DR and Zircal-45 while having better handleability.

The composite insulation materials disclosed herein were optimized according to density, aerogel-fiber ratio, additive content and aerogel chemistry to be least disruptive to and most predictable for battery cell assembly. For example, aerogel-fiber ratio and additive content used to prepare the non-flexible composite insulation materials disclosed herein resulted in composite insulation materials having a density in the range of about 0.20 g/cc to about 1.0 g/cc. The amount of additives (e.g. opacifiers and/or fire-class additives) in the non-flexible composite insulation materials can be about 40 weight % relative to metal oxide content within the composite insulation material or more.

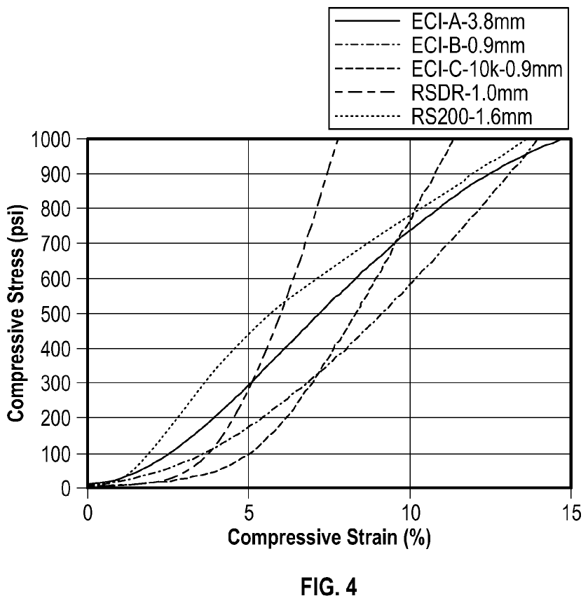

FIG. 4 depicts the stress-strain curves of exemplary composite insulation materials disclosed herein (ECI-A, B, and C having varying densities in the range of about 0.20 g/cc to about 1.2 g/cc) for battery prototyping against the incumbent refractory ceramic end cap insulations, RS-DR and RS-200 available from ZIRCAR Refractory Composites, Inc. ECI-A, B, and C were compressed under different pressures to obtain the material thickness of 3.8 mm, 0.9 mm and 0.9 mm respectively prior to testing mechanical performances of the exemplary composite insulation materials.

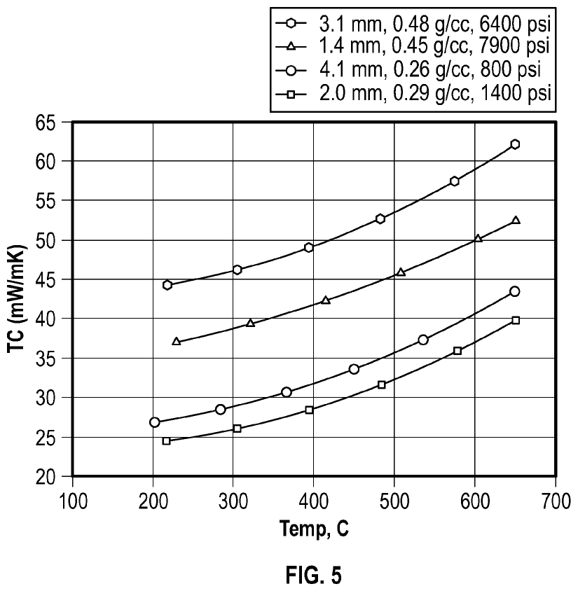

Exemplary composite insulation materials include silica aerogel (TEOS/MTES), Quartzel glass fiber reinforcement, and silicon carbide at about 40 wt % of the silica. The material was cast at a thickness of 4-5 mm. The materials were designed to achieve final thicknesses, matching the incumbent insulation materials, at about 4.2 mm, about 1.0 mm and between about 1.0 mm to about 4.2 mm (FIG. 2A, FIG. 2B, FIG. 3A, FIG. 3B, and FIG. 4). The exemplary composite insulation material can be further broken down into two classes: one set pre-compressed to 1,000 psi and the other to ˜10,000 psi. In addition to meeting the mechanical expectations with the composite insulation material candidates, the thermal conductivity performance is substantially lower than the incumbent materials such as RS-DR and Zircal-45. FIG. 5 shows thermal conductivity of four exemplary composite insulation materials (having density of 0.48 g/cc, 0.45 g/cc, 0.26 g/cc and 0.29 g/cc) with respect to varying temperatures between 100° C. and 700° C. The four composite insulation materials presented in FIG. 5 according to multiple embodiments of the present disclosure were compressed under different pressures (6400 psi, 7900 psi, 800 psi, 1400 psi) to obtain material thickness of 3.1 mm, 1.4 mm, 4.1 mm and 2.0 mm respectively prior to measurement of thermal conductivities. Thermal conductivities of the exemplary materials shown in FIG. 5 are less than 60 mW/m-K at 600° C. For comparison, RS-DR has a thermal conductivity (TC) of 649 mW/m-K at 600° C. while Zircal-45 has a TC of 117 mW/m-K at the same temperature.

The prepared non-flexible composite insulation materials were machined to the required prototype dimensions as end cap insulations and then installed in the battery build and tested. The non-flexible composite insulation materials of the present disclosure having approximately 1 mm and 4.2 mm thicknesses were used for prototype build and tested. Open circuit evaluation at a pre-conditioned temperature of 117° F. were performed for around 50 minutes. The units were opened and the quality of the insulation materials was assessed. For all units containing the composite insulation materials disclosed herein, no signs of damage, cracking or delamination were observed.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component, or step. Likewise, a single element, component, or step may be replaced with a plurality of elements, components, or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions, and advantages are also within the scope of the disclosure.

1. A non-flexible composite insulation material comprising a metal oxide matrix, an opacifying compound, and a fibrous material optionally comprising a polymeric binder, wherein the non-flexible composite insulation material is reinforced with the fibrous material, the non-flexible composite insulation material having a density greater than about 0.20 g/cc and a flexural modulus greater than about 10,000 psi.

2. A non-flexible composite insulation material comprising a metal oxide matrix reinforced with a fibrous material embedded therein, wherein the fibrous material optionally comprises a polymeric binder, and wherein an opacifying compound is dispersed throughout the metal oxide matrix, the non-flexible composite insulation material having a density greater than about 0.20 g/cc and wherein the opacifying compound is present at greater than about 40 weight % relative to metal oxide content within the composite insulation material.

3. The non-flexible composite insulation material of claim 2, wherein almost all or portions of the fibrous material is aligned perpendicular to the thickness direction of the metal oxide matrix.

4. The non-flexible composite insulation material of claim 1, wherein the metal oxide comprises silica, alumina, titania, ceria, yttria, vanadia or any combination thereof.

5. The non-flexible composite insulation material of claim 4, wherein the metal oxide matrix comprises silica.

6. The non-flexible composite insulation material of claim 1, wherein the metal oxide is a compressed aerogel matrix.

7. The non-flexible composite insulation material of claim 1, wherein the opacifying compound is selected from B4C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

8. The non-flexible composite insulation material of claim 7, wherein the opacifying compound is silicon carbide.

9. The non-flexible composite insulation material of claim 1, wherein the fibrous layer comprises organic polymer-based fibers, inorganic fibers, carbon-based fibers or a combination thereof.

10. The non-flexible composite insulation material of claim 9, the inorganic fibers are selected from glass fibers, rock fibers, metal fibers, boron fibers, ceramic fibers, basalt fibers, or combination thereof.

11. The non-flexible composite insulation material of claim 10, wherein the inorganic fiber comprises a glass fiber.

12. The non-flexible composite insulation material of claim 11, wherein the glass fiber is a silica-based glass fiber.

13. The non-flexible composite insulation material of claim 1, wherein the fibrous layer comprises discrete fibers, woven materials, non-woven materials, a mat, a felt, a batting, a lofty batting, chopped fibers, or a combination thereof.

14. The non-flexible composite insulation material of claim 1, the polymeric binder comprises polyvinyl alcohol.

15. The non-flexible composite insulation material of claim 1, having an average thickness of less than 10 mm and a thickness variation of less than 10%.

16. The non-flexible composite insulation material of claim 1, having a thermal conductivity of about 60 mW/m-K or less at 600° C.

17. The non-flexible composite insulation material of claim 1, having a density in the range of about 0.20 g/cc to about 1.0 g/cc.

18. The non-flexible composite insulation material of claim 1, having a flexural modulus in the range of about 10,000 psi to about 100,000 psi.

19. The non-flexible composite insulation material of claim 1, wherein the composite material substantially lacks organic moieties.

20. The non-flexible composite insulation material of claim 1, wherein the composite material is mechanically compressed material.

21. The non-flexible composite insulation material of claim 1, the opacifying compound is present in a range of about 40 weight % to about 60 weight % relative to metal oxide content within the composite insulation material.

22. A thermal battery comprising the non-flexible composite insulation material of any one of the preceding claims.

23. A method of improving the performance of a thermal battery comprising incorporating the non-flexible composite insulation material of any one of the preceding claims into the thermal battery.

24. A method for preparing a non-flexible composite insulation material, comprising:
a. providing a reinforced aerogel composite comprising a metal oxide matrix, an opacifying compound, and a fibrous material optionally comprising a polymeric binder;
b. exposing the aerogel composite to a heat treatment in a reduced oxygen or air atmosphere, wherein the heat treatment comprises exposure to one or more temperatures between 500° C. and 700° C.; and
c. mechanically compressing the aerogel composite in the direction perpendicular to the predominant direct of the fibrous material, thereby preparing the non-flexible composite insulation material.

25. The method of claim 24, wherein density of the non-flexible composite insulation material is about 5 to 100 times higher than the density of the reinforced aerogel composite.

26. The method of claim 24, wherein the thermal conductivity of the non-flexible composite insulation material at 600° C. is substantially unchanged relative to an uncompressed reinforced aerogel composite having substantially the same composition.

27. The method of claim 24, wherein the total duration of the heat treatment is between 1 minutes and 120 minutes.

28. The method of claim 24, wherein the aerogel composite is compressed by less than 80% in volume.

29. The method of claim 24, wherein the aerogel composite is compressed under a pressure of about 500 psi to about 10,000 psi.

30. The method of claim 24, wherein the metal oxide matrix comprises silica.

31. The method of claim 24, wherein the metal oxide matrix is a compressed aerogel matrix.

32. The method of claim 24, wherein the opacifying compound is present in a range of about 40 weight % to about 60 weight % relative to metal oxide content within the non-flexible composite insulation material.

33. A method of producing a non-flexible composite insulation material, comprising:
a. providing a casting surface and a flat casting frame, wherein an inner boundary of the casting frame encloses a casting area on the casting surface;
b. providing a sol-gel solution;
c. combining the sol-gel solution with an opacifying compound;
d. placing the fibrous material into the casting area;
e. combining the sol-gel solution with the fibrous material in the casting area;
f. allowing the sol-gel solution to transition into a gel material, thereby forming a reinforced gel;
g. drying the reinforced gel composition to produce a reinforced aerogel composite;
h. heating the reinforced aerogel composite to temperatures between 500° C. and 700° C. treatment in a reduced oxygen or air atmosphere; and
i. mechanically compressing the aerogel composite under about 500 psi to about 10,000 psi, thereby preparing the non-flexible composite insulation material.

34. The method of claim 33, wherein the sol-gel solution comprises TEOS and/or MTES.

35. The method of claim 33, wherein the reduced oxygen atmosphere comprises less than 5% oxygen by volume.

36. The method of claim 33, wherein the drying comprises carbon dioxide.

37. The method of claim 33, wherein the non-flexible composite insulation material has a density in the range of about 0.20 g/cc to about 1.0 g/cc.

38. The method of claim 33, wherein the non-flexible composite insulation material has a flexural modulus in the range of about 10,000 psi to about 100,000 psi.

39. The method of claim 33, wherein the opacifying compound is present in a range of about 40 weight % to about 60 weight % relative to metal oxide content within the non-flexible composite insulation material.
